(19) United States
(12) Patent Application Publication
(10) Pub. No.: US 2007/0265412 A1
(43) Pub. Date: Nov. 15, 2007

(54) EXTENDERS FOR FLUOROCHEMICAL TREATMENT OF FIBROUS SUBSTRATES

(75) Inventors: Dean M. Moren, North St. Paul, MN (US); Stewart H. Corn, St. Paul, MN (US); Carol-Lynn Spawn, West Lakeland Township (Stillwater), MN (US); Robert J. Meier, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/382,376

(22) Filed: May 9, 2006

(51) Int. Cl. C08G 18/81

(52) U.S. Cl. 528/45

(57) ABSTRACT

Compositions including aliphatic and blocked aromatic polyurethanes are described as extenders, and, particularly as textile auxiliaries, for use with fluorochemical polymers in treating substrates, for example fibrous substrates, such as textile fabrics or yarns.

### FIELD OF THE INVENTION

The present invention relates to non-fluorinated blocked isocyanate auxiliaries having low cost and improved storage stability for use in fluorochemical treatment of substrates, e.g., textile yarns.

### BACKGROUND OF THE INVENTION

Treatments with fluorochemical compositions are known to confer hydrophobicity and oleophobicity to substrates, particularly fibrous substrates, e.g., textile yarns. Hydrophobic, oleophobic textile yarns exhibit improved stain repellency and improved stain release. Fluorochemical treatments are relatively expensive and are often used in combination with less expensive non-fluorinated “extenders”. Among known extenders, blocked isocyanates are a desirable class since they are inexpensive, easy to prepare, and very effective. In addition, blocked isocyanate extenders are typically delivered as emulsions in water. Unfortunately, such blocked isocyanate extender emulsions often exhibit poor stability on storage and detrimentally affect fabric softness and color. Thus there is a need to find improved blocked isocyante extenders.

### SUMMARY OF THE INVENTION

The present invention provides a blocked isocyanate extender containing a blend of an aliphatic polyurethane, which is optionally blocked, and a blocked aromatic polyurethane, which confers excellent emulsion storage stability, excellent performance, acceptable fabric discoloration, and acceptable fabric softness, when combined with fluorochemical compositions for treatment of textile fabrics or yarns.

Accordingly the present invention in one embodiment is a non-fluorinated blocked isocyanate including: 1) an aliphatic polyurethane prepared from the reaction of an aliphatic polyisocyanate and a polypropylene glycol monoalkyl ether, and, optionally, a polyethylene glycol monoalkyl ether, and, optionally, a blocking group, and 2) a blocked aromatic polyurethane prepared from the reaction of an aromatic polyisocyanate and a blocking group.

In another embodiment, the present invention provides a treatment composition in the form of a solution or dispersion (emulsion) containing the non-fluorinated blocked isocyanate extender as above-defined with a fluorochemical composition containing a perfluoroalkyl-containing polymer.

In still another embodiment of the invention, there is provided an article, e.g. textile fabric or yarn or other fibrous substrate, having a cured coating from the above emulsion containing the fluorochemical composition and the non-fluorinated blocked isocyanate extender.

The invention further provides a method of treating a substrate, such as a fibrous substrate including a textile fiber or yarn by applying an emulsion of the above fluorochemical composition and extender, and allowing the resulting coating to cure.

### DETAILED DESCRIPTION OF THE ILLUSTRATIVE EMBODIMENTS

The non-fluorinated blocked isocyanate of the present invention combines a blend of an aliphatic polyurethane and a blocked aromatic polyurethane. In one embodiment, the blend contains each component in a weight ratio of from about 70:30 to about 30:70 and in another embodiment, from about 60:40 to about 40:60.

The aliphatic polyurethane is obtained as the reaction product of an aliphatic polyisocyanate and at least a polypropylene glycol monoalkyl ether. The reaction product may also contain as optional components a polyethylene glycol monoalkyl ether and/or a blocking group.

Aliphatic polyisocyanates are used as they provide excellent light stability. The aliphatic polyisocyanate in one embodiment has a molecular weight of at least about 350 g/mole. Suitable aliphatic polyisocyanates include diisocyanates, triisocyanates and mixtures thereof. Examples include hexamethylenediisocyanate, 2,2,4-trimethyl-1,6-hexamethylenediisocyanate, and 1,2-ethylenediisocyanate, dicyclohexylmethane-4,4′-diisocyanate, aliphatic triisocyanates such as 1,3,6-hexamethylenetriisocyanate, cyclic trimer of hexamethylenediisocyanate and cyclic trimer of isophorone diisocyanate (isocyanurates). Other examples of aliphatic polyisocyanates include, but are not limited to, those selected from the group consisting of 1,4-tetramethylene diisocyanate, hexamethylene 1,4-diisocyanate, hexamethylene, 1,6-diisocyanate (HDI), 1,12-dodecane diisocyanate, 2,2,4-trimethyl-hexamethylene diisocyanate (TMDI), 2,4,4-trimethyl-hexamethylene diisocyanate (TMDI), 2-methyl-1,5-pentamethylene diisocyanate, dimer diisocyanate, the urea of hexamethylene diisocyanate, the biuret of hexamethylene 1,6-diisocyanate (HDI) (available as Desmodur™ N-100 and N-3200 from Bayer Corporation, Pittsburgh, Pa.), the isocyanurate of HDI (available as Desmodur™ N-3300 and Desmodur™ N-3600 from Bayer Corporation, Pittsburgh, Pa.), a blend of the isocyanurate of HDI and the uretdione of HDI (available as Desmodur™ N3400 available from Bayer Corporation, Pittsburgh, Pa.), and mixtures thereof.

The polypropylene and polyethylene glycol monoalkyl ethers may range in average molecular weight from about 300 to about 2,000 g/mole, or in another embodiment the polypropylene glycol monoalkyl ethers may range from about 900 to 1700 g/mole and the polyethylene glycol monoalkyl ethers may range from about 300 to 800 g/mole. The glycol monoalkyl ethers may have from 1 to 12 carbon atoms for the alkyl groups. In one embodiment the glycol monoalkyl ethers may have from 1 to 4 carbon atoms in either the polypropylene and/or the polyethylene glycol. In one embodiment, the polypropylene glycol is a monobutyl ether and the polyethylene glycol is a monomethyl or a monoethyl ether.

Aromatic polyisocyanates of the present inventions are more economical. Suitable aromatic polyfunctional isocyanate compounds include, but are not limited to, those selected from the group consisting of 2,4-toluene diisocyanate (TDI), 2,6 toluene diisocyanate, an adduct of TDI with trimethylolpropane (available as Desmodur™ CB from Bayer Corporation, Pittsburgh, Pa.), the isocyanurate trimer of TDI (available as Desmodur™ IL from Bayer Corporation, Pittsburgh, Pa.), diphenylmethane 4,4′-diisocyanate (MDI), diphenylmethane 2,4′-diisocyanate, 1,5-diisocyanato-naphthalene, 1,4-phenylene diisocyanate, 1,3-phenylene diisocyanate, 1-methyoxy-2,4-phenylene diisocyanate, 1-chlorophenyl-2,4-diisocyanate, and mixtures thereof. Suitable aromatic polyfunctional isocyanate compounds may have even higher functionality, including isocyanates comprising methylene-arylene structures (PAPI).

A “blocked isocyanate” is a polyisocyanate where at least a portion of the isocyanate groups have been reacted with a blocking agent. The blocked isocyanate of the present invention is an aromatic polyisocyanate and, optionally, an aliphatic polyisocyanate. Isocyanate blocking agents are compounds that upon reaction with an isocyanate group yield a group that is unreactive at room temperature with compounds that at room temperature normally react with an isocyanate but which group at elevated temperature reacts with isocyanate reactive compounds. Generally, at elevated temperatures the blocking group will be released from the blocked polyisocyanate group thereby generating the isocyanate group again which can then react with an isocyanate reactive group, such as may be found on the surface of a fibrous substrate. Blocking agents and their mechanisms have been described in detail in “Blocked isocyanates III.: Part. A, Mechanisms and chemistry” by Douglas Wicks and Zeno W. Wicks Jr., Progress in Organic Coatings, 36 (1999), pp. 14-172. Preferred blocking agents include arylalcohols such as phenols, lactams such as ε-caprolactam, δ-valerolactam, γ-butyrolactam, oximes such as formaldoxime, acetaldoxime, methyl ethyl ketone oxime, cyclohexanone oxime, acetophenone oxime, benzophenone oxime, 2-butanone oxime or diethyl glyoxime. Further suitable blocking agents include bisulfite and triazoles.

The blocked aromatic polyurethane and the aliphatic polyurethane, which is a condensation product of an aliphatic polyisocyanate, a polyglycol monoalkyl ether and, optionally, a blocking agent, as above defined, are prepared by reacting the respective polyisocyanates with the other components in the presence of a catalyst such as an organic tin compound and under reaction conditions commonly employed and known in the art. Suitable catalysts include, but are not limited to, tin II and tin IV salts such as stannous octanoate, dibutyltin dilaurate, dibutyltin diacetate, dibutyltin di-2-ethylhexanoate, and dibutyltinoxide. Examples of useful tertiary amine compounds include triethylamine, tributylamine, tripropylamine, bis(dimethylaminoethyl) ether, morpholine compounds such as ethyl morpholine, and 2,2′-dimorpholinodiethyl ether, 1,4-diazabicyclo[2.2.2]octane (DABCO, Aldrich Chemical Co., Milwaukee, Wis.), and 1,8-diazabicyclo[5.4.0.]undec-7-ene (DBU, Aldrich Chemical Co., Milwaukee, Wis.). Tin compounds are preferred.

The above defined extender or auxiliary of the present invention is combined with a perfluoroalkyl-containing polymer for treating a substrate, particularly, a fibrous substrate. The perfluoroalkyl polymers, for example, are described in U.S. Pat. Nos. 4,834,764, 5,324,763, 6,437,077 and 6,890,360 among others. These patents are incorporated herein by reference. One embodiment includes perfluoropolyurethanes where the perfluoroalkyl group, R_{f}, has from 2 to 12 carbon atoms, preferably from 3 to 6 carbon atoms, and more preferably 4 carbons. Perfluoroalkyl polymers having 3 to 6 carbon atoms are known to have better environmental properties.

Also contemplated as fluorochemical urethanes to be combined with the extenders of the present invention are perfluoropolyethers as described in US patent publications 2004/0077237 and 2004/0077238. These US patent publications are incorporated herein by reference. Also, there are indications that fluorinated polyether compounds having a fluorinated polyether moiety derivable from hexafluoropropylene oxide and having a molecular weight of at least about 750 g/mole would more effectively eliminate from the body of living organisms as compared to long chain perfluoroaliphatic compounds (US patent publication 2004/0124396).

The composition for treating substrates, i.e. the treatment composition, comprises the ratio of a perfluoralkyl-containing polymer to the extender/auxiliary compound of the present invention and may vary from about 12:1 to about 1:12 and is typically from about 3:1 to about 6:1. In one embodiment the perfluoralkyl-containing polymer is a fluorochemical urethane.

The treatment composition for fibrous substrates comprises the chemical compositions of the present invention and at least one solvent. When applied to fibrous substrates, the treatment compositions impart stain-release characteristics and exhibit durability (i.e., they resist being worn-off) when exposed to wear and abrasion from use, cleaning, and the elements.

The chemical compositions of the present invention can be dissolved or dispersed in a variety of solvents to form coating compositions suitable for use in coating the chemical compositions of the present invention onto a substrate. Fibrous substrate treatment compositions may contain from about 0.1 to about 50 weight percent chemical composition. Preferably the chemical composition is used in the coating composition at about 0.1 to about 10 weight percent, most preferably from about 2 to about 4 weight percent.

Suitable solvents include water, alcohols, esters, glycol ethers, amides, ketones, hydrocarbons, chlorohydrocarbons, chlorocarbons, and mixtures thereof. Depending upon the substrate to which the composition is being applied, water is the preferred solvent because it does not raise any environmental concerns and is accepted as safe and non-toxic.

The treatment compositions of the present invention can be applied as to a wide variety of fibrous substrates resulting in an article that displays durable stain-release properties. The articles of the present invention comprise a fibrous substrate having a treatment derived from at least one solvent and a chemical composition of the present invention. After application and curing of the coating composition, the substrate displays durable stain-release properties.

The treatment compositions of the present invention can be applied to a wide variety of fibrous substrates including woven, knit, and nonwoven fabrics, textiles, carpets, leather, and paper. Substrates having nucleophilic groups, such as cotton are preferred because they can bond to the isocyanate groups of the chemical compositions of the present invention, thereby increasing durability of the fiber treatment. Any application method known to one skilled in the art can be used including spraying, dipping immersion, foaming, atomizing, aerosolizing, misting, flood-coating, and the like.

To impart release/repellency/resistance characteristics to a fibrous substrate, the coating composition of the present invention is applied to the substrate and is allowed to cure (i.e., dry), at ambient or elevated temperature.

In order to affect treatment of the fibrous substrate the fibrous substrate is contacted with the blocked isocyanate extender of the invention, preferably in combination with a fluorochemical composition. For example, the substrate can be immersed in the treatment composition. The treated substrate can then be run through a padder/roller to remove excess fluorochemical composition and dried or cured. The treated substrate may be dried at ambient temperature or may alternatively or additionally be subjected to a heat treatment, for example, in an oven. A heat treatment is typically carried out at temperatures between about 50° C. and about 190° C. depending on the particular system or application method used. In general, a temperature of about 120° C. to about 180° C., in particular of about 150° C. to about 180° C. for period of about 20 seconds to about 10 minutes, preferably about 3 to about 5 minutes, is suitable. Alternatively, the chemical composition can be applied by spraying the composition on the fibrous substrate. An ambient cure preferably takes place at approximately 15° C. to about 35° C. (i.e. ambient temperature) until dryness is achieved, up to approximately 24 hours. With either heat-treatment or ambient cure, the chemical composition can also form chemical bonds with the substrate and between molecules of the chemical composition.

The choice of either heat-treatment or ambient cure often depends on the desired end-use. For consumer applications, where the composition may be applied to household laundry or carpeting, and ambient cure is desired. For industrial applications, where the fibrous substrate, such as a textile might normally be exposed to elevated temperatures during production, elevated temperature cure or heating-treatment may be desirable. The blocked isocyanate extenders of the invention are preferably cured by heat treatment.

The amount of the treating composition applied to the fibrous substrate is chosen so that a sufficiently high level of the desired properties are imparted to the substrate surface without substantially affecting the look and feel of the treated substrate. Such amount is usually such that the resulting amount of the blocked isocyanate on the treated fibrous substrate will be between about 0.01% and about 1.7% by weight based on the weight of the fibrous substrate and the fluorochemical urethane composition on the treated fibrous substrate will be between about 0.05% and about 5% by weight based on the weight of the fibrous substrate, known as solids on fiber or SOF. The amount that is sufficient to impart desired properties can be determined empirically and can be increased as necessary or desired.

Fibrous substrates that can be treated with the treatment composition include in particular textiles. The fibrous substrate may be based on synthetic fibers, e.g. polyester, polyamide and polyacrylate fibers or natural fibers, e.g., cellulose fibers as well as mixtures thereof. The fibrous substrate may be a woven as well as non-woven substrate. Preferred substrates are cellulosic materials such as cotton, rayon, TENCEL™ and blends of cellulosic materials.

The resulting treated substrates, derived from at least one solvent and a chemical composition of the present invention, have been found to resist soils and/or stains and/or to release soils and/or stains with simple washing methods. The cured treatments have also been found to be durable and hence to resist being worn-off due to wear and abrasion from use, cleaning, and the elements.

The invention will now be further illustrated with reference to the following examples without the intention to limit the invention thereto. All parts and percentages are by weight unless stated otherwise.

### EXAMPLES

### Test Methods

Oil Repellency Test

This test measures the resistance of treated fabric to oil-based insults. A drop of one standard surface tension fluid (of a series of 8, with decreasing surface tensions) is dropped on a treated fabric. If after thirty seconds there is no wetting, the next highest standard number fluid (next lowest surface tension) is tested. When the lowest number fluid soaks into the fabric, the next lower number is the rating. For example, the fabric will receive a 3 rating, if the number 4 fluid wets the fabric. A more detailed description of the test is written in the American Association of Textile Chemists and Colorists (AATCC) technical manual (2006), TM-118-2002.

Water Repellency Test

This test measures the resistance of treated fabric to water based challenges. A drop of one standard surface tension fluid (of a series of 8, with decreasing surface tensions, based on water and water/isopropyl alcohol mixtures where 100% water is a 0 rating, and a mixture of 40% water, 60% IPA is an 8 rating) is placed on a treated fabric to form a bead. If after thirty seconds there is no wetting, the next highest standard number fluid (next lowest surface tension) is tested. When the lowest number fluid soaks into the fabric, the next lower number is the rating. For example, the fabric will receive a 3 rating, if the number 4 fluid wets the fabric. A more detailed description of the test is written in AATCC TM-193-2004.

Stain Release Test

This test evaluates the release of forced-in stains from the treated fabric surface during simulated home laundering, and is similar to AATCC TM-130-2000, with modifications described as follows. Five drops of Kaydol® white mineral oil (available Sonneborn, Inc., Tarrytown, N.Y.), 5 drops of Mazol® corn oil (available from ACH Food Companies, Inc.) and/or 5 ml Welch's® grape juice (Welch Foods Inc.) are dropped onto the fabric surface in separate puddles. The puddles are covered with glassine paper, and weighted with a 0.25-pound weight each for 60 seconds. The weights and glassine paper are removed from the fabric. The fabric sample is hung for 60 minutes, and then washed, dried, and evaluated against a rating board, and assigned a number rating from 1 to 5. A 5 rating represents total removal of the stain, whereas a 1 rating is a very dark stain.

Durability Procedure

The Oil Repellency, Water Repellency, and Stain Release Tests were run on treated fabric that had been washed (for example, 5 or 20 consecutive launderings) followed by tumble drying, as described below. The treated samples were placed in a washing machine along with untreated ballast fabric (1.9 kg of bleached cotton fabric in the form of generally square, hemmed 8100 cm² sheets). A commercial detergent (Tide® liquid, available from Procter and Gamble, 75 g) was added and the washer was filled to high water level with hot water (41° C.+/−2° C.). The substrate and ballast load were washed 5 or 20 times using a 12 minute normal wash cycle. The substrate and ballast were dried together in a conventional tumble drier at 65+/−5° C. for up to 45 minutes. Before testing, the substrates were conditioned at room temperature for about 4 hours.

Preparation of the Aliphatic Urethane

In a reaction vessel equipped with a stirrer 20.27 grams (16.89 meq) of poly(propylene glycol) monobutyl ether (1200 molecular weight, available from Aldrich, Milwaukee, Wis.) and 4.00 grams (5.33 meq) of poly(ethylene glycol) monomethyl ether (750 molecular weight, also available from Aldrich) were dissolved in 50 grams of ethyl acetate. The solution was heated to boiling at atmospheric pressure and 20 grams azeotrope was allowed to distill. To this solution was added 8.62 grams (44.44 meq) of Desmodur N3300 (an aliphatic polyisocyanate resin based on hexamethylene diisocyanate, available from Bayer, Pittsburgh, Pa.) followed by 0.02 grams of dibutyltin dilaurate (available from Air Products, Allentown, Pa.). The solution was heated to 75° C. with stirring and then was stirred at that temperature for two hours. The solution was then allowed to cool to 40° C. 1.93 grams (22.22 meq) of 2-Butanone oxime (available from Tokyo Chemical Industry America, Portland, Oreg.) was then added to the solution and the solution was heated and stirred at 75° C. for one hour. The solution was then allowed to cool to room temperature and was then diluted with ethyl acetate to 50.0% solids.

Preparation of the Blocked Aromatic Polyurethane

In a reaction vessel equipped with a stirrer a solution was prepared from 77.96 grams (247.9 meq) of Desmodur L 75 (an aromatic polyisocyanate based on toluene diisocyanate, available as a 75% solids ethyl acetate solution from Bayer, Pittsburgh, Pa.) and 60.51 grams of ethyl acetate. To this solution was added 21.53 grams (247.49 meq) of 2-Butanone oxime (available from Tokyo Chemical Industry America, Portland, Oreg.). Following an initial exotherm, the solution was heated at 75° C. for 2.5 hours. The solution was then allowed to cool to room temperature.

### Example 1 and Comparative Examples C1 and C2

### Emulsification of the Aliphatic Urethane Together with the Blocked Aromatic Polyurethane

A solution was prepared containing 14.10 grams of the aliphatic polyurethane solution described above, 15.90 grams of the blocked aromatic polyurethane solution described above and 1.58 grams of ethyl acetate. The solution was stirred and heated to 65° C. To this heated solution was added 0.48 grams Arquad® 2HT-75 (di(hydrogenated tallow)dimethylammonium chloride, available from Akzo Nobel, Chicago, Ill.) and 0.48 grams Arquad® 12-50 (dodecyltrimethylammonium chloride, available from Akzo Nobel). The solution was then allowed to cool to 40° C. and 37.50 grams of deionized water was added. The mixture was stirred rapidly for 20 minutes and cooled to 22° C., then emulsified by ultrasonic action for three minutes using a Branson Model 450 Sonifier (available from Branson Ultrasonics Corp., Danbury, Conn.) and 70/30 on/off cycling during which it warmed to about 40° C. Ethyl acetate was removed by vacuum distillation under reduced pressure (50 mm Hg) while heating with a 50° C. water bath. The stripped emulsion (33.5% solids) was then diluted with deionized water to 30.0% solids.

Heat stability testing was performed on the Example 1 emulsion. Emulsion samples were enclosed in each of five 1.5-drams vials and the vials were then placed in a 65° C. oven. One vial was removed from the oven after each of the time periods shown in Table 1 below and the volume percent solidified material was visually estimated. For comparison, two commercially available blocked aromatic isocyanate emulsions were also tested, NK Assist™ V-2 (C1), available from Nicca U.S.A., Inc., Fountain Inn, S.C. and Hydrophobol® XAN (C2), available from Ciba Specialty Chemicals Corporation, High Point, N.C.

TABLE 1

| | Estimated volume percent solidified | | | | |
|---|---|---|---|---|---|
| | After 3 | After 10 | After 14 | After 21 | After 28 |
| | days | days | days | days | days |
| Example 1 | <3% | <3% | 5% | 5% | 5% |
| C1 (NK Assist ™ | 100% | 100% | 100% | 100% | 100% |
| V-2) | | | | | |
| C2 (Hydrophobol ® | <3% | 5% | 10% | 90% | 90% |
| XAN) | | | | | |

### Examples 2, 3 and Comparative Example C3

### Treatment Compositions and Fabric Treatment

A premix was prepared containing 21.60 grams of 3M™ Protective Material PM-490 (fluorochemical emulsion available from 3M Company, St. Paul, Minn.), 43.20 grams of 3M™ Protective Material PM-930 (fluorochemical emulsion available from 3M Company, St. Paul, Minn.), 3.50 grams of Wet-Aid™ NRW (nonionic surfactant, available from Noveon, Cleveland, Ohio) and water (1433.2 grams). Examples 2 and 3 were prepared by diluting aliquots of the premix with water and then combining the premix with the emulsion of Example 1 as shown below in Table 2. For comparison a sample was also prepared with Hydrophobol® XAN extender (C3).

TABLE 2

| | | | Example 1 | |
|---|---|---|---|---|
| | Premix | Water | Emulsion | Hydrophobol ® XAN |
| Example | (grams) | (grams) | (grams) | (grams) |
| 2 | 214.51 | 32.00 | 3.49 | none |
| 3 | 214.51 | 33.64 | 1.85 | none |
| C3 | 214.51 | 33.64 | none | 1.85 |

The treatment compositions were applied to tan or white cotton knit fabric (open end, t-shirt knit, Fruit of the Loom) using known padding processes. The fabric was dipped into a bath containing blocked isocyanate extender and fluorochemical composition and immediately sent through a set of rubber rollers to squeeze out the excess liquid. The fabric was dried for ten minutes at 190° F. (88° C.) and then cured for 1 minute at 355° F. (179° C.). When dry the fabric had a total treatment solids coating ranging from about 1.0% to 1.3% solids by weight of the fabric total weight. The treated tan cotton knit fabric samples were tested for Oil Repellency (OR), Water Repellency (WR) and Stain Release (SR) according to the above test methods. The treated white cotton knit fabric samples were tested for Stain Release (SR). The durability of the fabric treatments was also evaluated by running the tests after 5 and 20 launderings. The results are shown in Tables 3 and 4.

TABLE 3

| | | | SR | SR |
|---|---|---|---|---|
| Example | OR | WR | (Mineral Oil) | (Corn Oil) |
| | Initial | | | |
| 2 | 4 | 4 | 3 | 4 |
| 3 | 5 | 4 | 3 | 4 |
| C3 | 4 | 4 | 3 | 4 |
| | After 5 launderings | | | |
| 2 | 3 | 4 | 3.5 | 3.5 |
| 3 | 3.5 | 3 | 3.5 | 3.5 |
| C3 | 2.5 | 3 | 3 | 4 |
| | After 20 launderings | | | |
| 2 | 2 | 0 | 3.5 | 4 |
| 3 | 1 | 0 | 3.5 | 4 |
| C3 | 1.5 | 0 | 3.5 | 4 |

TABLE 4

| | SR (Grape Juice) | | |
|---|---|---|---|
| Example | Initial | After 5 launderings | After 20 launderings |
| 2 | 3.8 | 3.7 | 2.2 |
| 3 | 3.5 | 3.7 | 4.0 |
| C3 | 2.8 | 3.5 | 3.7 |

### Examples 4 and Comparative Example C4

### Treatment Compositions and Fabric Treatment

The Example 1 emulsion was combined with a single fluorochemical emulsion, 3M™ Protective Material PM-930, Wet-Aid™ NRW and water, as shown below in Table 5. For comparison a sample was also prepared with Hydrophobol® XAN extender (C4).

TABLE 5

| | | Wet-Aid ™ | | Example 1 | Hydrophobol ® |
|---|---|---|---|---|---|
| Exam- | Water | NRW | PM-930 | Emulsion | XAN |
| ple | (grams) | (grams) | (grams) | (grams) | (grams) |
| 4 | 698 | 1.5 | 44.1 | 6.2 | none |
| C4 | 698 | 1.5 | 44.1 | none | 6.2 |

The treatment compositions were applied to a khaki cotton woven fabric (Avondale) as described for Examples 2 and 3 above. The test samples were dried for twenty minutes at 210° F. (99° C.) and then cured for three minutes at 310° F., 325° F. or 340°F. (154° C., 163° C., or 171° C.), When dry the fabric had a total treatment solids coating of about 1.2% solids by weight of the fabric total weight. The fabric samples were tested for Oil Repellency (OR) and Water Repellency (WR) and Stain Release (SR) according to the above test methods. The durability of the fabric treatments was also evaluated by running the tests after 5 and 20 launderings. The results are shown in Table 6.

TABLE 6

| | Cure | | | | | SR |
|---|---|---|---|---|---|---|
| | Temperature | | | SR | SR | (Grape |
| Example | (° F.) | OR | WR | (Mineral Oil) | (Corn Oil) | Juice) |
| | | Initial | | | | |
| 4 | 310 | 4 | 3 | 3.5 | 4 | 2 |
| C4 | | 4 | 3 | 3.5 | 4 | 2 |
| 4 | 325 | 4 | 3 | 3.5 | 4 | 4.5 |
| C4 | | 4 | 4 | 3.5 | 4 | 3 |
| 4 | 340 | 4 | 4 | 3 | 3.5 | 2.5 |
| C4 | | 4.5 | 4 | 3.5 | 4 | 3 |
| | | After 5 launderings | | | | |
| 4 | 310 | 4 | 3 | 4.5 | 4.5 | 3 |
| C4 | | 4 | 3 | 4 | 4.5 | 3 |
| 4 | 325 | 5 | 3 | 4.5 | 4.5 | 3.5 |
| C4 | | 4 | 4 | 4 | 4.5 | 3.5 |
| 4 | 340 | 4 | 4 | 4 | 4.5 | 3.5 |
| C4 | | 4 | 4 | 4.5 | 4.5 | 3.5 |
| | | After 20 launderings | | | | |
| 4 | 310 | 2 | 0 | 4 | 4.5 | 3 |
| C4 | | 2 | 0 | 4 | 4.5 | 3 |
| 4 | 325 | 3 | 0 | 4 | 4.5 | 3 |
| C4 | | 2 | 3 | 4 | 4.5 | 3.5 |
| 4 | 340 | 3 | 2 | 4 | 4.5 | 3 |
| C4 | | 3 | 2 | 4 | 4.5 | 3 |

The above specification, examples and data provide a complete description of the manufacture and use of the composition of the invention. Since many embodiments described above can be made without departing from the spirit and scope of the invention, the invention resides in the claims hereinafter appended.

We claim:

1. A non-fluorinated blocked isocyanate composition comprising: an aliphatic polyurethane comprising the reaction product of an aliphatic polyisocyanate and a polypropylene glycol monoalkyl ether, and a blocked aromatic polyurethane comprising the reaction product of an aromatic polyisocyanate and a blocking group.

2. A composition of claim 1 wherein the reaction product of the aliphatic polyurethane further comprises a polyethylene glycol monoalkyl ether.

3. A composition of claim 1 wherein the reaction product of the aliphatic polyurethane further comprises a blocking group.

4. A composition of claim 1 wherein the weight ratio of aliphatic polyurethane to aromatic polyurethane is from about 70:30 to about 30:70.

5. A composition of claim 2 wherein the glycol monoalkyl ether has an average molecular weight from about 300 to about 2,000 g/mole.

6. A composition of claim 2 wherein the monoalkyl ether has from 1 to 12 carbon atoms.

7. A composition of claim 6 wherein the monoalkyl ether has from 1 to 4 carbon atoms.

8. A composition of claim 1 wherein the blocking group is an alkanone oxime.

9. A treatment composition comprising a solution or dispersion of a non-fluorinated blocked isocyanate composition of claim 1, a perfluoroalkyl-containing polymer, and a solvent.

10. A treatment composition of claim 9 wherein the solvent is selected from the group consisting of water, an organic solvent, and mixtures thereof.

11. An article comprising a substrate having a cured coating derived from a treatment composition of claim 9.

12. The article of claim 11 wherein the substrate is a fibrous substrate.

13. The article of claim 11 wherein the substrate is a textile yarn.

14. A method of imparting stain repellency and stain-release characteristics to a substrate comprising the steps of applying a treatment composition of claim 9, and allowing the coating composition to cure.

15. The method of claim 14 wherein the substrate is a fibrous substrate.
